(19) United States
(12) Patent Application Publication
(10) Pub. No.: US 2025/0165968 A1
(43) Pub. Date: May 22, 2025

(54) SYSTEMS AND METHODS FOR AUTONOMOUS INTERACTIONS WITH DELAYED ACTIVATION

(71) Applicant: Capital One Services, LLC, McLean, VA (US)

(72) Inventors: Leeyat Bracha TESSLER, Arlington, VA (US); John MARTIN, Brooklyn, NY (US); Dexter FERGUSON, Catonsville, MD (US); Jerry WU, New York, NY (US)

(73) Assignee: Capital One Services, LLC, McLean, VA (US)

(21) Appl. No.: 18/516,151

(22) Filed: Nov. 21, 2023

(51) Int. Cl. G06Q 20/40; G06Q 20/12

(52) U.S. Cl. CPC G06Q 20/401; G06Q 20/127

(57) ABSTRACT

Systems and methods for delayed interaction with an entity are disclosed. A method includes receiving data packets including data associated with an interaction between a user device and an entity. The data may include a completion date for the interaction and authentication data executable to activate the interaction with the entity. The method further includes receiving activation timing information from the entity comprising an estimated duration between an activation and a completion of the interaction. The method also includes generating, with reference to the activation timing information, primed activation data that includes the estimated activation date such that the interaction is complete by the completion date. On the estimated activation date, the primed activation data is activated, which includes accessing the entity using the authentication data, and executing the interaction with the entity on the estimated activation date.

### TECHNICAL FIELD

Various embodiments of this disclosure relate generally to systems and methods for delayed activation of an interaction with an entity and, more particularly, to systems and methods for estimating an activation date for an interaction such that the interaction is completed on a desired completion date.

### BACKGROUND

When obtaining an item online, an individual may determine that the item will be delivered while the individual will be away from home or otherwise unavailable and cannot retrieve the delivered item in a timely fashion. As such, the item may be left unprotected, e.g., at a doorstep or on a porch, etc. Waiting to obtain the item may cause the individual to forget to make the purchase altogether. In other situations, an individual may want to delay purchase and/or delivery of an item purchased online until more favorable circumstances, e.g., after obtaining additional resources or satisfying outstanding obligations.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for delayed interaction with an entity. A method may include receiving, by at least one processor, data packets including data associated with an interaction between a user device and an entity, the data including a completion date for the interaction, and the data further including authentication data executable to activate the interaction with the entity. The method may further include receiving, by the at least one processor, activation timing information from the entity including interaction activation options, the activation timing information comprising an estimated duration between an activation and a completion of the interaction. The method may also include, prior to an estimated activation date, generating, by the at least one processor and with reference to the activation timing information and the interaction activation options, primed activation data that includes the estimated activation date for the interaction such that the interaction is complete by the completion date, and on the estimated activation date, activating the primed activation data. Activating the primed activation data may include accessing the entity using the authentication data on the estimated activation date, and executing, by the at least one processor and with reference to the authentication data, the interaction with the entity on the estimated activation date.

In one aspect, a system for delayed interaction with an entity is disclosed. The system may include a memory storing instructions and a processor operatively connected to the memory and configured to execute the instructions to perform operations. The operations may include receiving data packets including data associated with an interaction between a user device and an entity, the data including a completion date for the interaction, and the data further including authentication data for activating the interaction with the entity, and receiving activation timing information from the entity including interaction activation options. The operations may further include, prior to an estimated activation date, generating, by the processor and with reference to the activation timing information and the interaction activation options, primed activation data that includes the estimated activation date for the interaction such that the interaction is complete by the completion date, and on the estimated activation date, activating the primed activation data. Activating the primed activation data may include accessing the entity using the authentication data on the estimated activation date, and executing, with reference to the authentication data, the interaction with the entity on the estimated activation date.

In another aspect, a non-transitory computer readable medium storing instructions is disclosed which, when executed by one or more processors, cause the one or more processors to perform operations for training a machine-learning model by extracting one or more targets from records. The operations may include receiving, by at least one processor and via user input, data packets including data associated with an interaction between a user device and an entity, the data including a completion date for the interaction, and the data further including authentication data for activating the interaction with the entity, receiving, by the at least one processor, activation timing information from the entity including interaction activation options, and receiving additional activation timing information from a third-party entity. Prior to an estimated activation date, the operations may include generating, by the at least one processor and with reference to the activation timing information and the interaction activation options, primed activation data that includes the estimated activation date for the interaction such that the interaction is complete by the completion date, and on the estimated activation date, activating the primed activation data. Activating the primed activation data may include accessing the entity using the authentication data on the estimated activation date, and executing, by the at least one processor and with reference to the authentication data, the interaction with the entity on the estimated activation date.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates an environment for delayed activation of an interaction with an entity, according to one or more embodiments.

FIG. 2 is a flowchart depicting an example method for delayed activation of an interaction with an entity, according to one or more embodiments.

FIG. 3 depicts a simplified functional block diagram of a computer that may be configured as a device for executing the methods disclosed here, according to exemplary embodiments of the present disclosure.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In an exemplary use case, a user may interact with an entity online to acquire an item, but desire to receive the item at a particular time, e.g., later than a predicted delivery window. In such cases, it may be beneficial to delay and then automatically activate the interaction such that the item arrives at the particular time. During an online interaction with the entity, the user may decide to obtain an item. During completion of the interaction, the user may be given an option (e.g., shown via a user interface) to select a desired delivery window, e.g., a delayed window relative to when the item might be delivered if purchased immediately. An interaction activation system may receive several inputs to determine when the interaction will occur such that the item arrives approximately at the desired delivery window. For example, the interaction activation system may scrape one or more websites for delivery option data, which may include delivery timing information and price information for the item. The interaction activation system may also be integrated with (e.g., communicate with, or request information from) a delivery tracking service to determine when the same or similar items arrived following an interaction (e.g., a purchase). In some cases, access to email or other information associated with the user or others may be useful to obtain information related to delivery timing and/or tracking information. Following receipt of the various inputs, the interaction activation system may determine when the interaction is to be activated, and may inform the user of the date of activation. In an example, a user may select a delivery window such that, for example, an item is delivered so as to be timely for an event such as a birthday. In another example, a user may select that purchase and/or delivery is delayed until a known event, such as a payday, a release date of the item, a re-stocking of the item, etc.

On the determined day of activation, the interaction activation system may automatically activate the interaction (e.g., complete the purchase of the item). In some cases, the user may be notified before the system automatically activates the interaction to provide an opportunity for the user to prevent the interaction from being activated (e.g., executed). In other cases, the system may request permission from the user before automatically activating the interaction. If, during the time between the user's decision to purchase the item and the determined activation date, the item is no longer available (e.g., the item is out of stock), the system may provide a notification to the user device regarding the lack of availability. The system may suggest alternative options for the user to either wait for the item to become available, or consider an alternative available item.

The interaction activation system may allow for recurring interactions, including, for example, automated subscriptions to obtain an item on a regular schedule. The system may also be incorporated into a calendar-integrated service, e.g., where a gift or the like is set to be purchased for other users and delivered on a particular date. For example, the user may input names, addresses, and birthdays for friends, along with a list of possible gift items for those friends into the system. The system may automatically purchase an item for each person's birthday ahead of time such that the items arrive on or before each person's birthday.

In the disclosed embodiments, a system according to one or more aspects of the present disclosure (e.g., interaction activation system) enables a user to delay activation of an interaction with an entity such that the interaction is complete by a desired date. In some embodiments, such actions may be performed within a single system during a single interaction within the system, which is not possible using conventional methods and systems. For instance, because the system enables an interaction to be activated and completed without intervention from a user, various embodiments of the system of the present disclosure reduce required processing power, memory, and communication resources needed to facilitate activating and executing interactions with certain entities. Such an interaction activation system may result in less data transfer and data bandwidth usage for a computer/communication system. In other words, the interaction activation system may result in less required processing power and communication bandwidth in comparison to conventional systems. Additionally, in view of the foregoing, the interaction activation system may result in more user-friendly, consistent, reliable, accurate, and efficient method for delaying, activating, executing, and completing interactions between a user device and an entity.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used herein, the term “determining” or “evaluating” encompasses a wide variety of actions. For example, “determining” and “evaluating” may include calculating, computing, processing, deriving, investigating, looking up (e.g., looking up in a table, a database or other data repository, or another data structure), ascertaining, and/or the like. Also, “determining,” and “evaluating” may include receiving (e.g., receiving information), accessing (e.g., accessing data in a data repository), and/or the like. Also, “determining” may include resolving, selecting, choosing, establishing, and the like.

As used herein, the terms “element,” “module,” “component,” and “system” may refer to a computer-related entity, either hardware, a combination of hardware and software, software, or software in execution. For example, a module may be, but is not limited to being, a machine-executable process running on a processor, a processor, an object, a thread of execution, a machine-executable program, and/or a computer. By way of illustration, both a process running on a server and the server may be a module or a component. One or more modules or components may reside within a process and/or thread of execution. In some implementations, a module may be localized on one computer and/or distributed among two or more computers.

Various aspects or features will be presented herein in terms of systems that may include a number of devices, components, modules, and the like. It is to be understood and appreciated that the various systems may include additional devices, components, modules, etc. and/or may not include all of the devices, components, modules, etc., discussed in connection with the figures. A combination of these approaches may also be used.

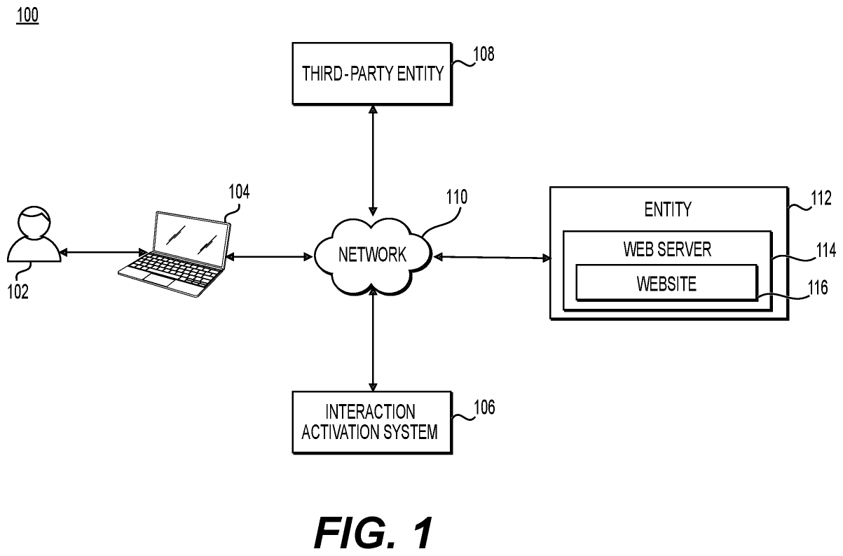

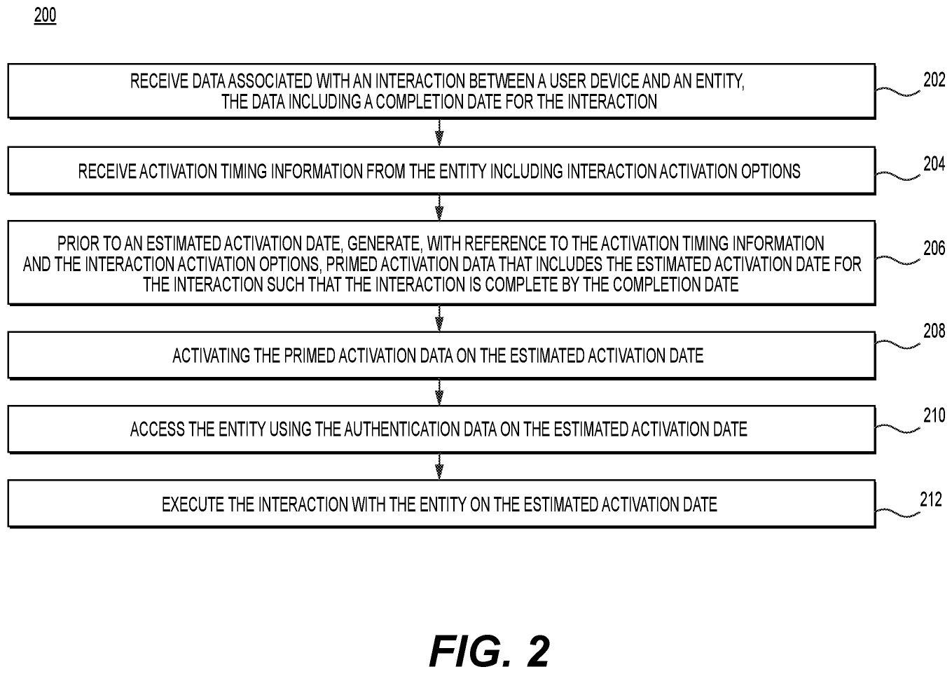

Referring to FIGS. 1-3, aspects are depicted with reference to one or more components and one or more methods that may perform the actions of functions described herein. Although the operations described below in FIG. 2 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing he described actions of functions.

FIG. 1 illustrates an environment 100 for delaying interaction activation between a user device and an entity, according to one or more embodiments. Environment 100 of FIG. 1 depicts user 102, user device 104, an interaction activation system 106, a third-party entity 108, and an entity 112. Entity 112 may include one or more web servers, such as web server 114. Each web server 114 may host and/or include data associated with one or more websites, such as website 116. All or some of the components of environment 100 may be connected (e.g., in operable communication) to each other via network 110, and/or in some cases may be directly connected to each other, bypassing network 110. Components of the environment 100 may communicate and/or be arranged in any suitable manner.

As illustrated in FIG. 1, a user 102 may be a human user that interfaces with user device 104, for example, to communicate with other components of environment 100, such as entity 112 or interaction activation system 106. Although FIG. 1 illustrates one user and one user device, environment 100 may include any number of users that each interact with environment 100 using corresponding user devices.

User device 104 may represent various types of computing devices with which user 102 may interact. For example, user device 104 may be a mobile device (e.g., a cell phone, a smartphone, a personal digital assistant (PDA), a tablet, a laptop, a watch (e.g., a smartwatch), a wearable device, etc.). In some embodiments, the user device 104 may be a non-mobile device (e.g., a desktop computer or server).

Entity 112 may be an entity with which user 102 interacts to begin, schedule, delay, activate, execute, and complete an interaction. Entity 112 may be an online retailer from which user 102 desires to obtain an item. Entity 112 may own, maintain, and manage web server 114 and administer website 116 to facilitate the sale of merchandise. User 102 may interact with entity 112 to acquire an item.

During completion of an interaction, e.g., a checkout phase for a purchase of an item by user 102, entity 112 may generally determine timing information including a prediction (e.g., an estimate) for a delivery date of the item. In some embodiments, interaction activation system 106 may aggregate such data e.g., from one or more users, and/or may source such data from the entity 112. Such data may be used, e.g., by the interaction activation system 106 to generate estimations for delivery times for prospective purchases. Such estimates may be based on several factors including historical data analysis, routing algorithms, machine learning, geospatial analysis, weather forecasting, capacity planning, and customer feedback and reviews. For example, entity 112 and/or interaction activation system 106 may analyze historical data for previous deliveries, including shipment origins, destinations, distances, transit times, and delivery dates. By analyzing this data, entity 112 and/or interaction activation system 106 may identify patterns and trends that help estimate future delivery times. Routing algorithms may refer to algorithms used to optimize the delivery process. These algorithms may take into account factors such as traffic conditions, weather, and delivery volume to calculate the most efficient routes and delivery times. Geospatial analysis may involve using location-based data to optimize delivery routes and provide more accurate delivery estimates. For example, by considering road networks, traffic patterns, and other geographic factors, entity 112 and/or interaction activation system 106 may make more accurate delivery predictions. Entity 112 and/or interaction activation system 106 may review customer feedback and reviews to determine in some cases whether items arrived on the predicted delivery date. For example, one or more reviewers may complain on a review or in feedback that the item arrived later than the predicted delivery date. An estimated difference (e.g., a duration) between a date of purchase and a date of delivery may be referred to as activation timing information. Some or all of the analysis conducted regarding activation timing information may be performed by third-party entity 108.

Interaction activation system 106 may be integrated with or interact with entity 112, in some cases as a browser plugin. During checkout for a user 102 with entity 112, interaction activation system 106 may be activated on the website 116 and ask user 102 for a preferred interaction completion (e.g., delivery) date. If the preferred interaction completion date is later than the standard predicted completion date, interaction activation system 106 may determine that activation of the interaction (e.g., execution of the purchase) should be delayed such that the interaction is completed (e.g., the purchased item is delivered) on the preferred completion date. Interaction activation system 106 may receive the completion date for the interaction from entity 112.

Interaction activation system 106 may further receive authentication data executable to activate the interaction with the entity. For example, interaction activation system 106 may receive a username and password associated with user 102, allowing interaction activation system 106 to independently access entity 112 on a future date, such as an estimated activation date. In some cases user 102 may provide authentication data (e.g., username and password to access entity 112) directly to interaction activation system 106. In other cases, user 102 may give permission for entity 112 to provide the authentication data to interaction activation system 106.

Interaction activation system 106 may receive activation timing information from entity 112, which may include interaction activation option data. The activation timing information may include an estimated duration between an activation and a completion of the interaction (e.g., a prediction of a duration between a purchase date and a delivery date of an item purchased from entity 112 and delivered to user 102). In some embodiments, additional activation timing information may be received from third-party entity 108.

The interaction activation option data included with the activation timing information and received from entity 112 may include input from the user such as whether the user would like to be notified of any changes for the interaction between the receipt of the interaction activation options and activation of the interaction. Further, the interaction activation options may include indications as to whether user 102 requests to give final permission before execution of the interaction on the estimated interaction activation date. User 102 may provide this input by checking one or more boxes on website 116, via a web browser extension provided by interaction activation system 106 on website 116. Further interaction options may include indications as to whether user 102 would like interaction activation system 106 to provide similar alternative items for purchase in the case that the originally selected item is not available on the estimated activation date. Alternatively, user 102 may choose to merely cancel the interaction if the intended item is not available for purchase.

Interaction activation system 106 may estimate an activation date for the interaction between user 102 and entity 112 such that the interaction is complete by the completion date determined by user 102 and/or entity 112. In some embodiments, this may be accomplished by subtracting the estimated duration (e.g., number of days between activation and completion of the interaction) from the completion date of the interaction. Prior to the estimated activation date, interaction activation system 106 may generate primed activation data that includes the estimated activation date for the interaction. The primed activation data may include any data needed to activate (e.g., execute) the interaction with the entity on the estimated activation date. For example, the primed activation data may include authentication data to provide access to entity 112. On the estimated activation date, interaction activation system 106 may activate the primed activation data. Such activation of the primed activation data may include accessing entity 112 using the authentication data and executing the interaction with the entity. In an example, the primed activation data includes an executable that may be autonomously activated, e.g., without intervention by the user 102, such that the interaction is activated at a time configured such that the desired item arrives within the desired delivery window. Thus, in some embodiments, the primed activation data, when executed, may cause the interaction activation system 106 to autonomously interact with other systems, e.g., the entity 112, etc.

In some instances, prior to activation of the interaction, interaction activation system 106 may provide a notification (e.g., an email, push notification, etc.) to user 102 requesting a confirmation that the interaction may be activated. User 102 may respond via user device 104 and provide a confirmation that the interaction may be activated. In some cases, the notification is merely informational for user 102 to be aware that the interaction will be activated, and may not require any input from user 102. If any details related to the interaction before the estimated activation date, interaction activation system 106 may provide an update to user 102. The update may include a request to confirm an alternative interaction (e.g., a similar item to be purchased) or timeline (e.g., delay the purchase even more), or a notification that the interaction is to be cancelled or postponed. Settings for how interaction activation system 106 should respond in this situation may be fixed at the time user 102 interacts with entity 112 and/or interaction activation system 106.

Information related to the interaction may be stored within interaction activation system 106 and used to repeat the interaction at a future date one or more times. For example, user 102 may desire to set up a subscription service to have a particular item delivered on a regular basis (e.g., every month, quarter, year, etc.). By way of example, user 102 may desire to have an interaction completed on a particular date every month (e.g., have an item delivered on the 15^{th} of every month). Interaction activation system 106 may determine when an interaction should be activated each month such that the interaction is complete on the particular date. Interaction activation system 106 may then repeatedly activate the interaction each month.

Interaction activation system 106 may be managed by a financial services provider, e.g., a bank or credit card provider, of user 102. Accordingly, interaction activation system 106 may have access to funds and/or credit lines for user 102 and may use such funds and credit lines to complete interactions (e.g., make purchases) authorized by user 102. In some embodiments, when interaction activation system 106 receives an indication from entity 112 that an interaction is to be activated, resources (e.g., funds or credit lines) may be held (e.g., may not be accessible by user 102) in the interim between the initiation of the interaction and the activation of the interaction with entity 112. The funds or credit may be held in a separate virtual “account” that user 102 does not have easy or apparent access to. In reality, the resources may still be in the account of user 102 but may be hidden or appear to be inaccessible. This may give the illusion to user 102 that the resources have been spent or used.

In some embodiments, interaction activation system 106 may delay the interaction between user 102 and entity 112 until a credit card balance for user 102 is below a threshold. The threshold may be set by user 102. The interaction may be activated once the credit card balance is below the threshold set by user 102. The threshold may be dynamic and may be based on the price of the item to be purchased. For example, a credit card balance of user 102 may be high enough that user 102 does not have enough available credit to purchase the desired item. Once user 102 has sufficient credit available to make the purchase, the interaction may be automatically activated.

Third-party entity 108 may be a delivery service, or in some cases, may be a delivery tracking service. For example, third-party entity 108 may receive an item from entity 112 and a request to ship the item to an address associated with user 102. Third-party entity 108 may independently determine the activation timing information (e.g., activation timing information determined by entity 112) or provide additional activation timing information to interaction activation system 106. The additional activation timing information may include regular durations for similar interactions. Regular durations may refer to the amount of time between activation or execution of an interaction (e.g., an item is purchased from entity 112) and completion of the interaction (e.g., delivery of the item to user 102). Similar interactions may refer to other interactions between user 102 and entity 112 (e.g., purchases of different items from entity 112), interactions between other users and entity 112 (e.g., different users' purchases of the same item from entity 112), interactions between user 102 and a different entity, and interactions between other users and other entities.

In some cases, third-party entity 108 may have additional (e.g., direct and/or prioritized) access to tracking information and actual delivery dates in relation to dates of origination. In some embodiments, interaction activation system 106 may have access to an email account for user 102 to determine based on emails received from third-party entity 108 or entity 112 stating when an item purchased from entity 108 actually arrived. The information from the emails received by user 102 may be another point of data executable to more accurately predict a delivery date for an item purchased on a given date and may contribute to more accurate and useful activation timing information.

Web server 114 may host one or more websites such as website 116. Web server 114 may include one or more third-party electronic devices (e.g., computing devices or groups of computing devices), such as individual servers or groups of servers operating in a distributed manner. Web server 114 may communicate with other components of environment 100 including interaction activation system 106, third-party entity 108, or user device 104 via network 110. For example, web server 114 may receive requests for data from user device 104 or interaction activation system 106. Web server 114 may send the requested data via the network 110 to user device 104 or interaction activation system 106. In some examples, a user 102 may interact with web server 114 via user device 104. To facilitate the interaction with the user, web server 114 may present website 116 to user device 104. In some embodiments, web server 114 may host third-party websites created and administered by parties (e.g., entities) to interactions with user 102. While the term “website” is used herein, the website 116 may be a user interface other than a website or a webpage, such as a user interface of a client-side application executing on the user device 104, such as the user interface of an app executing on a laptop or a smartphone of the user and communicating with web server 114.

One or more of the components in FIG. 1 may communicate with each other and/or other systems, e.g., across network 110. In some embodiments, network 110 may connect one or more components of environment 100 via a wired connection (e.g., a USB connection). In some embodiments, network 110 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, third-party entity 108 may integrated in interaction activation system 106. In some embodiments, operations or aspects of one or more of the components discussed above may be distributed amongst one or more other components. Any suitable arrangement and/or integration of the various systems and devices of the environment 100 may be used.

FIG. 2 depicts an exemplary method 200 for delaying interaction with an entity, according to one or more embodiments. Method 200 may be performed by one or more processors and/or components of the environment 100 of FIG. 1, according to some embodiments of the disclosure. For example, one or more steps of method 200 may be performed by interaction activation system 106 of FIG. 1.

At step 202, the method 200 includes receiving data associated with an interaction between a user, e.g., via a user device, and an entity. The data may be received as data packets over a network. The data packets may be received via user input. The data received at step 202 may include a completion date for the interaction. The data may also include authentication data that may be used to activate the interaction with the entity.

At step 204, the method 200 includes receiving activation timing information from the entity including interaction activation options. The interaction activation options may include input from the user. The activation timing information may include an estimated duration between an activation and a completion of the interaction. In some embodiments, method 200 may further include receiving additional activation timing information from a third-party entity. The additional activation timing information may include regular durations for similar interactions.

At step 206, the method 200 includes, prior to an estimated activation date, generating primed activation data that includes the estimated activation date for the interaction such that the interaction is complete by the completion date. The primed activation data may be generated with reference to the activation timing information and the interaction activation options.

At step 208, the method 200 includes activating the primed activation data on the estimated activation date.

At step 210, the method 200 includes accessing the entity using the authentication data on the estimated activation date. In some cases, step 210 may be included as a part of step 208 of activating the primed activation data.

At step 212, the method 200 includes executing the interaction with the entity on the estimated activation date. In some embodiments, step 212 may also be included as a part of step 208 of activating the primed activation data. In some cases, prior to executing the interaction, a confirmation is received from the user. The confirmation may include an input on a user interface from the user confirming that the interaction is to be executed. Additionally, prior to executing the interaction with the entity on the estimated activation date, an indication may be provided to the user of an alteration to the interaction. In this case, an additional confirmation may be received from the user related to the alteration of the interaction.

The method 200 may include further steps not shown in FIG. 2. For example, the method 200 may include storing information related to the interaction such that the interaction is repeatable at a future date designated by the user. The method 200 may also include repeating completion of the interaction on a regular basis such that repeated interactions are completed on regularly scheduled dates. Other steps of method 200 may include holding resources necessary for completion of the interaction in a virtual account and expending the resources during execution of the interaction.

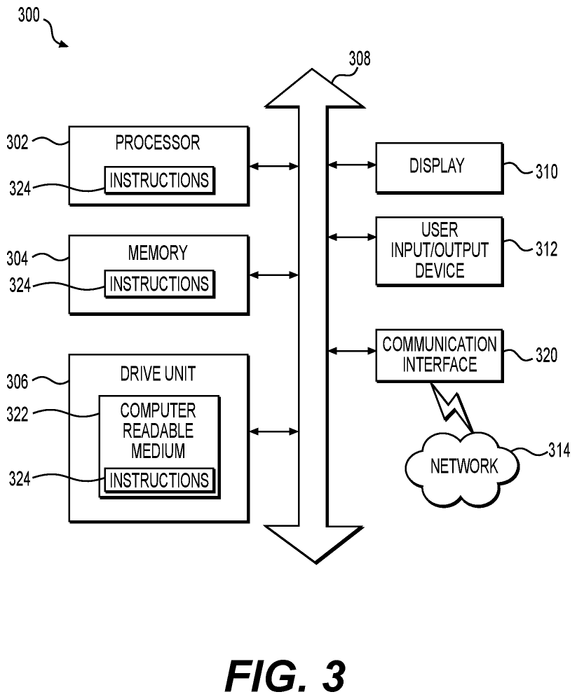

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure, such as, for example, interaction activation system 106 of FIG. 1. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications (e.g., via network 314, which may be an example of network 110 of FIG. 1). The computer 300 may also have a memory 304 (such as RAM) storing instructions 324 for executing techniques presented herein, although the instructions 324 may be stored temporarily or permanently within other modules of computer 300 (e.g., processor 302 and/or computer readable medium 322). The computer 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for delayed interaction with an entity, the method comprising:
receiving, by at least one processor, data packets including data associated with an interaction between a user and an entity, the data including a completion date for the interaction, and the data further including authentication data executable to activate the interaction with the entity;
receiving, by the at least one processor, activation timing information from the entity, the activation timing information comprising interaction activation options data and an estimated duration between an activation and a completion of the interaction;
prior to an estimated activation date, generating, by the at least one processor and with reference to the activation timing information and the interaction activation options data, primed activation data that includes the estimated activation date for the interaction such that the interaction is complete by the completion date; and
on the estimated activation date, activating the primed activation data, which includes:
accessing the entity using the authentication data on the estimated activation date; and
executing, by the at least one processor and with reference to the authentication data, the interaction with the entity on the estimated activation date.

2. The computer-implemented method of claim 1, wherein the interaction activation options data comprises input from a user device associated with the user.

3. The computer-implemented method of claim 1, further comprising receiving additional activation timing information from a third-party entity.

4. The computer-implemented method of claim 3, wherein the additional activation timing information comprises regular duration data for similar interactions.

5. The computer-implemented method of claim 1, further comprising:
prior to executing the interaction with the entity on the estimated activation date, receiving a confirmation from a user device associated with the user.

6. The computer-implemented method of claim 5, further comprising:
prior to executing the interaction with the entity on the estimated activation date, providing an indication to the user device of an alteration to the interaction; and
receiving an additional confirmation from the user device related to the alteration of the interaction.

7. The computer-implemented method of claim 1, further comprising:
storing information related to the interaction such that the interaction is repeatable at a future date designated by a user device associated with the user.

8. The computer-implemented method of claim 7, further comprising:
repeating completion of the interaction on a regular basis.

9. The computer-implemented method of claim 1, further comprising:
holding resources necessary for completion of the interaction in a virtual account; and
expending the resources during execution of the interaction.

10. The computer-implemented method of claim 1, wherein receiving the data packets further comprises receiving the data packets via user input.

11. A system for delayed interaction with an entity, the system comprising:
a memory storing instructions; and
a processor operatively connected to the memory and configured to execute the instructions to perform operations including:
receiving data packets including data associated with an interaction between a user device and an entity, the data including a completion date for the interaction, and the data further including authentication data for activating the interaction with the entity;
receiving activation timing information from the entity, the activation timing information including interaction activation options;
prior to an estimated activation date, generating, by the processor and with reference to the activation timing information and the interaction activation options, primed activation data that includes the estimated activation date for the interaction such that the interaction is complete by the completion date; and
on the estimated activation date, activating the primed activation data, which includes:
accessing the entity using the authentication data on the estimated activation date; and
executing, with reference to the authentication data, the interaction with the entity on the estimated activation date.

12. The system of claim 11, wherein the activation timing information comprises an estimated duration between the estimated activation date for the interaction and the completion date for the interaction.

13. The system of claim 11, wherein the processor is configured to execute the instructions to perform additional operations including receiving additional activation timing information from a third-party entity.

14. The system of claim 13, wherein the additional activation timing information comprises regular duration data for similar interactions.

15. The system of claim 11, wherein the processor is configured to execute the instructions to perform additional operations including:
prior to executing the interaction with the entity on the estimated activation date, receiving a confirmation from the user device.

16. The system of claim 15, wherein the processor is configured to execute the instructions to perform additional operations including:
prior to executing the interaction with the entity on the estimated activation date, providing an indication to the user device of an alteration to the interaction; and
receiving an additional confirmation from the user device related to the alteration of the interaction.

17. The system of claim 11, wherein the processor is configured to execute the instructions to perform additional operations including:
storing information related to the interaction such that the interaction is repeatable at a future date designated by the user device.

18. The system of claim 17, wherein the processor is configured to execute the instructions to perform additional operations including:
repeating completion of the interaction on a regular basis.

19. The system of claim 11, wherein the processor is configured to execute the instructions to perform additional operations including:
holding resources necessary for completion of the interaction in a virtual account; and
expending the resources during execution of the interaction.

20. A non-transitory computer readable medium storing instructions which, when executed by one or more processors, cause the one or more processors to perform operations for delayed interaction with an entity, the operations comprising:
receiving, by at least one processor and via user input, data packets including data associated with an interaction between a user device and an entity, the data including a completion date for the interaction, and the data further including authentication data for activating the interaction with the entity;
receiving, by the at least one processor, activation timing information from the entity, the activation timing data including interaction activation options;
receiving additional activation timing information from a third-party entity;
prior to an estimated activation date, generating, by the at least one processor and with reference to the activation timing information and the interaction activation options, primed activation data that includes the estimated activation date for the interaction such that the interaction is complete by the completion date; and
on the estimated activation date, activating the primed activation data, which includes:
accessing the entity using the authentication data on the estimated activation date; and
executing, by the at least one processor and with reference to the authentication data, the interaction with the entity on the estimated activation date.
